(19) United States
(12) Patent Application Publication
(10) Pub. No.: US 2014/0016900 A1
(43) Pub. Date: Jan. 16, 2014

(54) OPTICAL CONNECTOR AND FERRULE

(71) Applicant: Hiroyoshi Maesoba, Mie (JP)

(72) Inventor: Hiroyoshi Maesoba, Mie (JP)

(73) Assignees: AUTONETWORKS TECHNOLOGIES, LTD., Mie (JP); SUMITOMO ELECTRIC INDUSTRIES, LTD., Osaka (JP); SUMITOMO WIRING SYSTEMS, LTD., Mie (JP)

(21) Appl. No.: 14/000,983

(22) PCT Filed: Apr. 10, 2012
(86) PCT No.: PCT/JP2012/059748

§ 371 Date: Aug. 22, 2013

(30) Foreign Application Priority Data
Apr. 11, 2011 (JP) 2011-087396
Apr. 11, 2011 (JP) 2011-087468

(51) Int. Cl. G02B 6/38

(52) U.S. Cl. CPC G02B 6/381
USPC 385/60

(57) ABSTRACT

A ferrule includes a flange that projects outward in the diameter direction of the ferrule, and a shaft portion that extends from the flange, away from the tip of the ferrule along the axial direction of the ferrule. A male-side connector includes a coil spring that is fitted around the shaft portion and biases a ferrule forward in the mating direction of the male connector, and a spring receiving portion that holds the coil spring from behind in the mating direction of the male connector. The cross-sectional shape of the shaft portion is a regular polygonal shape according to which vertices of the cross section of the shaft portion come into contact with the inner periphery of the coil spring. A female-side connector includes a flange receiving portion comes into contact with the flange from behind in the mating direction of the female-side connector.

### TECHNICAL FIELD

The present invention relates to an optical connector and a ferrule.

### BACKGROUND ART

Conventionally, there is known to be an optical connector that includes a male-side connector and a female-side connector that can be mated together (e.g., see Patent Document 1).

The male-side connector and the female-side connector have a housing for accommodating a ferrule that is fixed to the tip of an optical fiber that is exposed from the end portion of an optical cord configured by an optical fiber whose outer periphery is enclosed in a sheath. The housing also accommodates a coil spring that biases the ferrule forward in the direction of connector mating.

When the two connectors are mated together, the tip of the ferrule accommodated in the male-side connector and the tip of the ferrule accommodated in the female-side connector are pressed against each other by the elastic force of the coil springs. The optical fiber accommodated in the male-side connector and the optical fiber accommodated in the female-side connector are thus optically connected to each other.

### CITATION LIST

### Patent Documents

Patent Document 1: JP 2002-169061A

### SUMMARY OF INVENTION

### Technical Problem

According to the above-described configuration, coil springs are accommodated in both the male-side connector and the female-side connector. Both of the connectors thus need to have a space for ensuring the stroke of the coil springs. Since the space for ensuring the stroke of the coil springs is formed so as to extend in the mating direction of the male-side connector and the female-side connector, there is a problem of difficulty in the reduction of the size in the mating direction of both of the connectors.

The present invention was achieved in light of the above-described situation, and an object thereof is to provide a reduced-size optical connector in which ferrules are reliably held. Another object is to provide a ferrule that is reliably held in an optical connector.

### Solution to Problem

One mode of the present invention is an optical connector including a first connector and a second connector that are mated to each other, wherein the first connector and the second connector are each attached to an end portion of an optical cord configured by an optical fiber whose outer periphery is enclosed in a sheath, in end portions of the optical cords located on a side on which the first connector and the second connector are attached, a ferrule that is accommodated in both the first connector and the second connector is fixed to a tip of the optical fiber that is exposed from the sheath, each of the ferrules includes a flange that projects outward in a diameter direction of the ferrule, and a shaft portion that extends from the flange, away from a tip of the ferrule along an axial direction of the ferrule, the first connector includes a coil spring that is fitted around the shaft portion and biases the ferrule forward in a mating direction of the first connector, and a spring receiving portion that holds the coil spring from behind in the mating direction of the first connector, and the second connector includes a holding portion that holds the ferrule.

According to the present invention, the ferrules are reliably held in the second connector by the holding portion. This enables reliably holding the ferrules in the second connector and reducing the size of the optical connector as a whole.

The following mode is preferable as a mode for carrying out the present invention.

A cross-sectional shape of each shaft portion is a regular polygonal shape according to which vertices of a cross section of the shaft portion come into contact with an inner periphery of the coil spring, and the holding portion is a flange receiving portion that is formed in the second connector and comes into contact with the flange from behind in a mating direction of the second connector, and a portion of the flange receiving portion that opposes the shaft portion is formed so as to mimic an outer shape of the shaft portion.

According to the above mode, the flanges of the ferrules that are shared by both the first optical connector and the second optical connector are locked in the flange receiving portion formed in the first housing of the first optical connector. This enables omitting a spring for locking the flange in the first optical connector, and reducing the size of the optical connector as a whole.

Also, since each shaft portion has a regular polygonal shape according to which the vertices of the cross section of the shaft portion come into contact with the inner periphery of the coil spring, the axis of the coil spring and the axis of the shaft portion can be aligned. This enables causing the axis of the ferrule and the axis of the coil spring to conform to each other. As a result, it is possible to hold the ferrules at the correct position, thus making it possible to reliably maintain the optical connection between the optical fiber attached to the first connector and the optical fiber attached to the second connector.

Note that the regular polygonal shape includes the shape of a regular polygon having chamfered vertices. In other words, although a shape technically ceases to be a regular polygon if the vertices are subjected to chamfer work, the present invention encompasses the case where such a shape is substantially accepted as being a regular polygon. The faces formed at the vertices of the regular polygon may be flat faces or curved faces. In the case where the faces formed at the vertices of the regular polygon are curved faces, a configuration is possible in which the faces formed at the vertices form portions of a circle. In other words, the shape of a regular polygon whose vertices are chamfered may be formed by cutting multiple identically-shaped arches in one circle, using the center of the circle as the center of point symmetry.

Also, each shaft portion has a regular polygonal cross-section. For this reason, the surface area of the shaft portion projected on the flange is smaller than that in the case where the shaft portion has a circular cross-section. This enables increasing the area of engagement between the flange and the flange receiving portion. Since the portion of the flange receiving portion that opposes the shaft portion is formed so as to mimic the outer shape of the shaft portion, the area of the shaft portion where the surface area thereof projected on the flange is smaller can be reliably used as an engagement area. As a result, the ferrules can be reliably held in the second connector.

The following mode is preferable as a mode for carrying out the present invention.

It is preferable that a sleeve for insertion of both the ferrule accommodated in the first connector and the ferrule accommodated in the second connector is accommodated in the second connector.

According to the above mode, when the first connector and the second connector are mated together, the ferrule accommodated in the first connector and the ferrule accommodated in the second connector are inserted into the sleeve accommodated in the second connector. The tip of the ferrule accommodated in the first connector and the tip of the ferrule accommodated in the second connector then come into contact. Since both of the ferrules are guided by the inner face of the sleeve, the axes of both of the ferrules can be reliably aligned. As a result, the optical fiber attached to the first connector and the optical fiber attached to the second connector can be reliably optically connected.

It is preferable that a flange housing portion that houses the flange is formed in the second connector, and a face of the flange housing portion that opposes the flange is formed so as to mimic an outer shape of the flange.

According to the above mode, the flange needs only be accommodated in the flange housing portion formed in a shape that mimics the outer shape of the flange, thus making it possible to easily hold the orientation of the flange at the correct position when the flange is accommodated in the flange housing portion.

The holding portion is a locking member that is formed as a separate member from the second connector and is formed so as to be locked to the shaft portion and be larger than the flange with respect to the diameter direction of the ferrule, and

the second connector includes a locking member receiving portion that comes into contact with the locking member from behind in a mating direction of the second connector.

According to the above mode, the ferrule is reliably held by the locking member receiving portion via the locking member. This enables reliably holding the ferrules in the second connector and reducing the size of the optical connector as a whole.

It is preferable that a shaft portion housing groove for accommodating the shaft portion is formed in the locking member.

According to the above mode, the ferrule and the locking member can be locked with a simple configuration in which the shaft portion is accommodated in the shaft portion housing groove.

It is preferable that the locking member is formed such that a pair of opening edge portions of the shaft portion housing groove can deform so as to spread open, and is formed such that an interval between the pair of opening edge portions is smaller than an outer diameter dimension of the shaft portion in a natural state.

When the ferrules are to be locked to the locking member, first, the shaft portions of the ferrules are pressed into the pair of opening edge portions of the shaft portion housing grooves. The pair of opening edge portions then deform so as to spread open. When the shaft portions are pressed further, the shaft portions pass through the opening edge portions that deformed so as to spread open, and enter the interior of the shaft portion housing grooves. As the shaft portions enter farther into the shaft portion housing grooves, the pair of opening edge portions deform so as to return to their natural state, and the shaft portions are held inside the shaft portion housing grooves. In this way, according to the present mode, the shaft portions can be reliably held by the locking member.

It is preferable that a face of the shaft portion housing groove that opposes the shaft portion is formed so as to mimic an outer shape of the shaft portion.

According to the above mode, it is possible to increase the surface area where the flanges and the locking member come into contact. This enables reliably holding the ferrules by the second housing via the locking member.

It is preferable that a shaft portion insertion hole for insertion of the shaft portion is formed in the locking member so as to pierce the locking member.

According to the above mode, it is possible to increase the surface area where the flanges and the locking member come into contact. This enables reliably holding the ferrules by the second housing via the locking member.

Also, at least one mode of the present invention is a ferrule for being fitted around and fixed to a terminal of an optical fiber, a shaft portion around which a coil spring is fitted being formed in the ferrule so as to extend in an axial direction of the ferrule, and a cross-sectional shape of the shaft portion being a regular polygonal shape according to which vertices of a cross section of the shaft portion come into contact with an inner periphery of the coil spring.

According to at least aspect of the present invention, each shaft portion has a regular polygonal shape according to which the vertices of the cross section of the shaft portion come into contact with the inner periphery of the coil spring, and therefore the axis of the coil spring and the axis of the shaft portion can be aligned. This enables causing the axis of the ferrule and the axis of the coil spring to conform to each other. As a result, it is possible to hold the ferrules at the correct position, thus making it possible to reliably maintain the optical connection between the optical fiber attached to the first connector and the optical fiber attached to the second connector.

### Advantageous Effects of Invention

According to the present invention, a ferrule can be reliably held in an optical connector. It is also possible to reduce the size of the optical connector.

### BRIEF DESCRIPTION OF DRAWINGS

FIG. 1 is a cross-sectional side view of an optical connector according to Embodiment 1 of the present invention.

FIG. 2 is a cross-sectional plan view of the optical connector according to Embodiment 1 of the present invention.

FIG. 3 is a cross-sectional plan view of a female-side connector according to Embodiment 1.

FIG. 4 is an exploded perspective view of an optical cord, an inner ring, and an outer ring.

FIG. 5 is a plan view of a female-side lower housing.

FIG. 6 is a side view of the female-side lower housing.

FIG. 7 is a back view of the female-side lower housing.

FIG. 8 is a bottom view of a female-side upper housing.

FIG. 9 is a side view of the female-side upper housing.

FIG. 10 is a back view of the female-side upper housing.

FIG. 11 is a plan view of a male-side lower housing.

FIG. 12 is a side view of the male-side lower housing.

FIG. 13 is a bottom view of a male-side upper housing.

FIG. 14 is a side view of the male-side upper housing.

FIG. 15 is a front view of the male-side upper housing.

FIG. 16 is a side view of a ferrule.

FIG. 17 is a cross-sectional view of the ferrule.

FIG. 18 is a back view of the ferrule.

FIG. 19 is a cross-sectional view of an optical connector according to Embodiment 2 of the present invention.

FIG. 20 is a cross-sectional view of a female-side connector according to Embodiment 2.

FIG. 21 is an exploded perspective view of an optical cord, an inner ring, and an outer ring.

FIG. 22 is a cross-sectional view of a male-side connector according to Embodiment 2.

FIG. 23 is a cross-sectional view of the male-side connector according to Embodiment 2.

FIG. 24 is a front view of a front housing according to Embodiment 2.

FIG. 25 is a side view of a ferrule.

FIG. 26 is a back view of the ferrule.

FIG. 27 is a back view of a locking member and ferrules according to Embodiment 2.

FIG. 28 is a back view of a locking member and ferrules according to Embodiment 3.

FIG. 29 is a back view of a locking member and ferrules according to Embodiment 4.

FIG. 30 is a back view of a locking member and ferrules according to Embodiment 5.

### DESCRIPTION OF EMBODIMENTS

### Embodiment 1

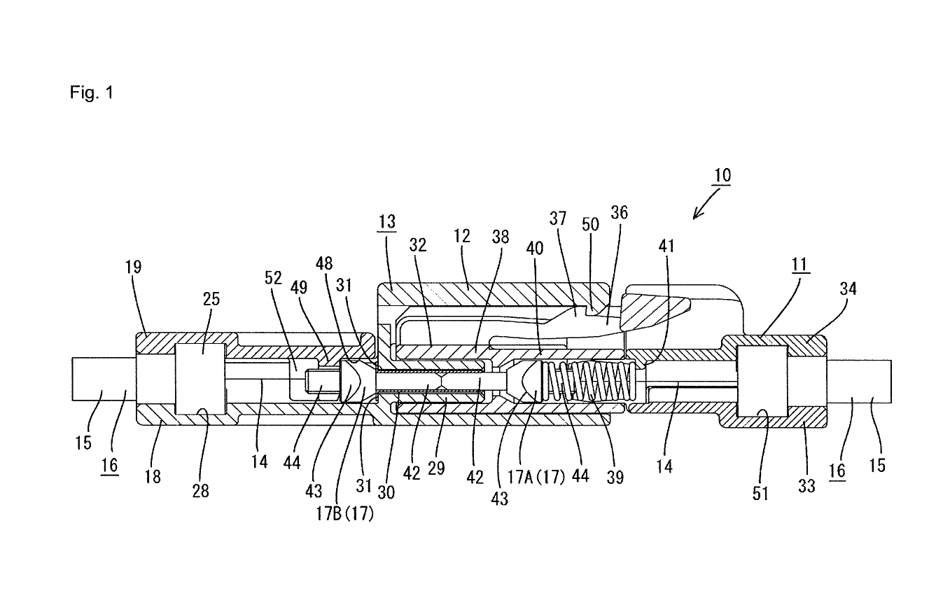

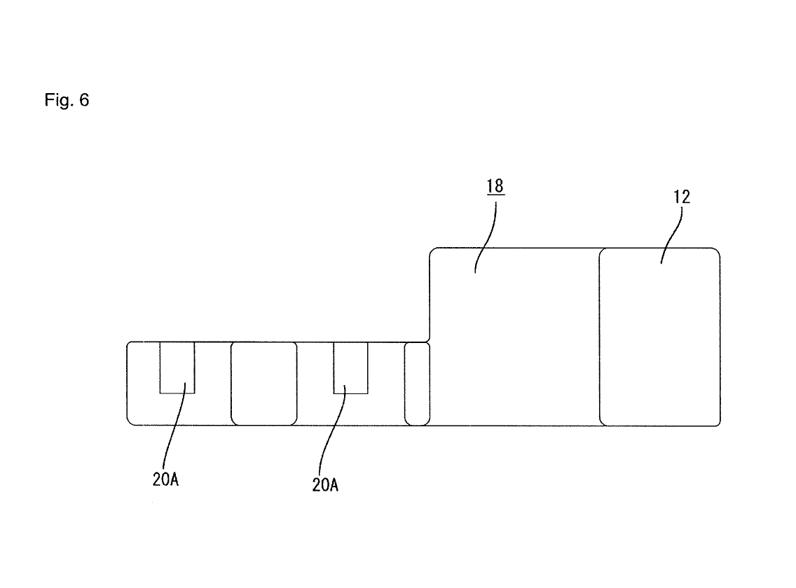

The following describes Embodiment 1 of the present invention with reference to FIGS. 1 to 18. An optical connector 10 of the present embodiment includes a male-side connector 11 (one example of a first connector) and a female-side connector 13 (one example of a second connector) that includes a hood portion 12 into which the male-side connector 11 is mated. The male-side connector 11 and the female-side connector 13 are each attached to the end portion of an optical cord 16 configured by an optical fiber 14 whose outer periphery is enclosed in a sheath 15. In the end portions of the optical cords 16 located on the side where the male-side connector 11 and the female-side connector 13 are attached, ferrules 17A and 17B are fixed to the tips of the optical fibers 14, which are exposed from the sheath 15 due to the sheath 15 being peeled back. The ferrule 17A is accommodated in the male-side connector 11, and the ferrule 17B is accommodated in the female-side connector 13. The ferrules 17A and 17B have the same shape and size, and are shared between the male-side connector 11 and the female-side connector 13.

Note that the collective term “ferrule 17” will be used in the following description when describing structures that are common to the ferrules 17A and 17B.

Also, in the following description, “upward” refers to the upward direction in FIG. 1, and “downward” refers to the downward direction in FIG. 1. Also, regarding the forward and backward directions, “forward” refers to the forward direction in the mating direction of the connectors 11 and 13, and “backward” refers to the backward direction in the mating direction. Accordingly, the forward and backward directions in the male-side connector 11 are oriented oppositely to the forward and backward directions in the female-side connector 13.

Female-Side Connector 13

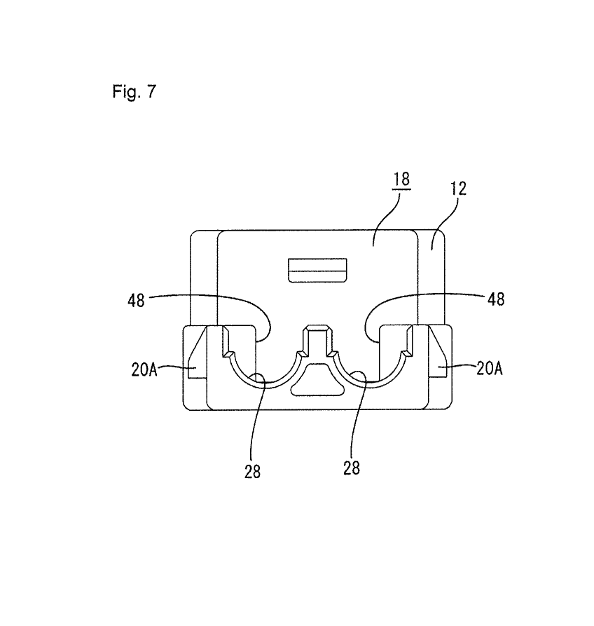

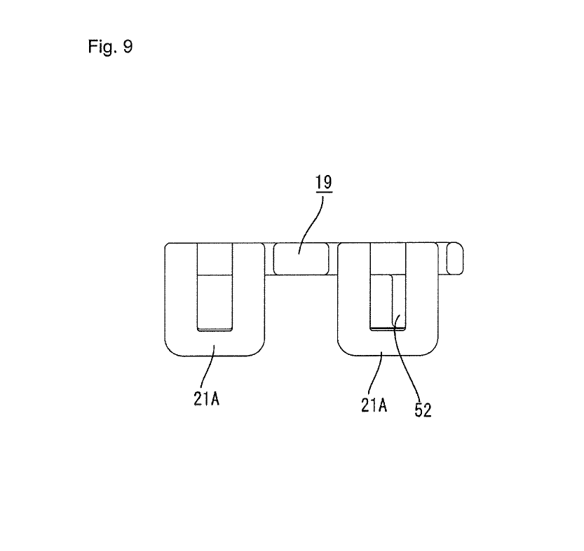

The female-side connector 13 includes a female-side lower housing 18 that is made of synthetic resin and includes a hood portion 12 that is open forward in the mating direction (rightward in FIG. 1), and a female-side upper housing 19 that is made of synthetic resin and attached to the female-side lower housing 18 from above. As shown in FIG. 7, lock projection portions 20A are formed on the outer side face of the female-side lower housing 18. Also, as shown in FIG. 9, lock receiving portions 21A are formed on the female-side upper housing 19 at positions that correspond to the lock projection portions 20A. The female-side lower housing 18 and the female-side upper housing 19 are integrally attached to each other by elastically engaging the lock projection portions 20A and the lock receiving portions 21A.

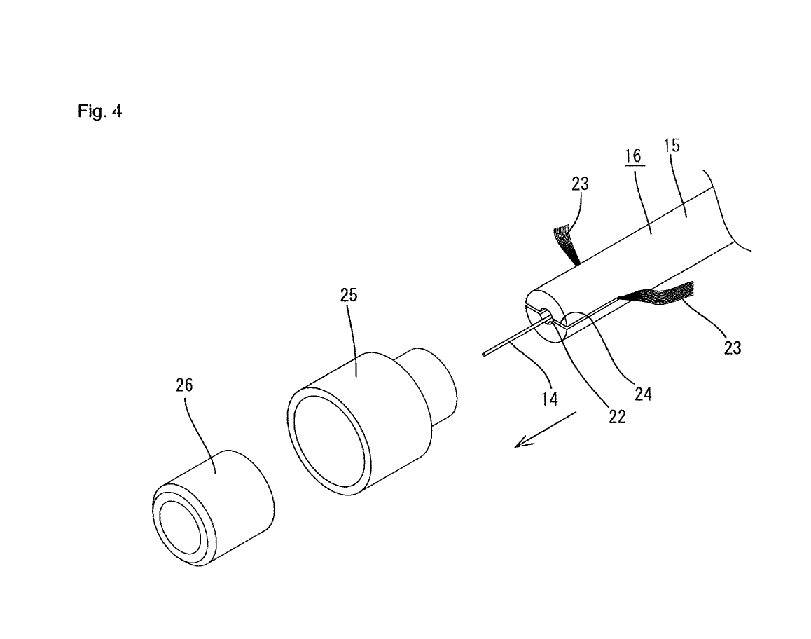

The female-side connector 13 internally accommodates the optical cord 16, the optical fiber 14 exposed from the end portion of the optical cord 16, and the ferrule 17B fixed so as to be fitted around the tip of the optical fiber 14. As shown in FIG. 4, a through-hole 22 that extends in the axial direction of the optical cord 16 is formed in the sheath 15 of the optical cord 16. One optical fiber 14 is inserted into this through-hole 22. A tensile force resisting member 23 is accommodated between the optical fiber 14 and the sheath 15 so as to suppress disconnection of the optical fiber 14 when tensile force is applied to the optical cord 16. The tensile force resisting member 23 is fibrous. A slit 24 that extends in the axial direction of the optical cord 16 is formed in the end portion of the sheath 15. The tensile force resisting member 23 is drawn out of the slit 24, the tensile force resisting member 23 is arranged between a metal outer ring 25 and a metal inner ring 26, and the outer ring 25 is swaged to the inner ring 26, thus clamping the tensile force resisting member 23 between the outer ring 25 and the inner ring 26. Also, the sheath 15 is fixed due to the outer ring 25 being fitted around the sheath 15 and then swaged to the sheath 15.

An outer ring housing groove 28 that accommodates the outer ring 25 is formed so as to extend in the forward-backward direction (left-right direction in FIG. 1) at a position toward the back end portion (position toward the left end portion in FIG. 1) of the female-side lower housing 18 and the female-side upper housing 19.

A fitting tube portion 29 is formed inside the hood portion 12 so as to project forward in the mating direction (rightward in FIG. 1) of the female-side connector 13. A sleeve 30, into which the ferrules 17 are inserted, is accommodated inside the fitting tube portion 29. The ferrule 17A and the ferrule 17B are both accommodated inside the sleeve 30. The sleeve 30 is substantially tubular, and is formed from a material capable of elastic deformation in the diameter direction, such as a metal or a ceramic. A pair of locking pieces 31 that project in the up-down direction are formed on the back end portion (left end portion in FIG. 4) of the sleeve 30. The sleeve 30 is restricted from moving forward (rightward in FIG. 1) due to the locking pieces 31 coming into contact with the back wall of the hood portion 12 from behind (from the left in FIG. 1).

Male-Side Connector 11

As shown in FIG. 1, the male-side connector 11 includes a front housing 32 that is made of synthetic resin and fitted into the hood portion 12, a male-side lower housing 33 that is made of synthetic resin and attached rearward (rightward in FIG. 1) of the front housing 32, and a male-side upper housing 34 that is made of synthetic resin, arranged rearward of the front housing 32, and attached to the upper side of the male-side lower housing 33.

The male-side connector 11 internally accommodates an optical cord 16, an optical fiber 14 exposed from the end portion of the optical cord 16, and a ferrule 17A fixed so as to be fitted around the tip of the optical fiber 14. An inner ring 26 and an outer ring 25 are attached to the end of the optical fiber 14. The optical fiber 14, the ferrule 17A, the inner ring 26, and the outer ring 25 have the same configurations as the corresponding members accommodated in the female-side connector 13, and therefore redundant descriptions will not be given for them.

An outer ring housing groove 51 that accommodates the outer ring 25 is formed so as to extend in the forward-backward direction (left-right direction in FIG. 1) at a position toward the back end portion (position toward the right end portion in FIG. 1) of the male-side lower housing 33 and the male-side upper housing 34.

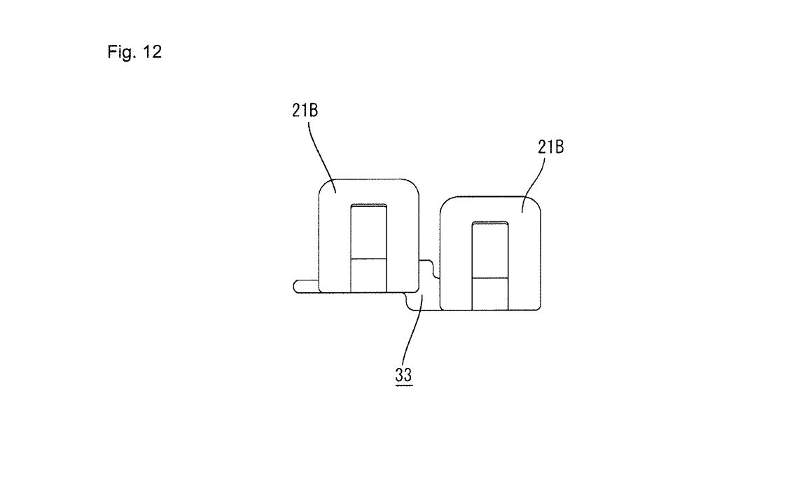

As shown in FIG. 14, lock projection portions 20B are formed on the outer side face of the male-side upper housing 34. Also, as shown in FIG. 12, lock receiving portions 21B are formed on the male-side lower housing 33 at positions that correspond to the lock projection portions B20. The male-side upper housing 34 and the male-side lower housing 33 are integrally attached to each other by elastically engaging the lock projection portions 20B and the lock receiving portions 21B.

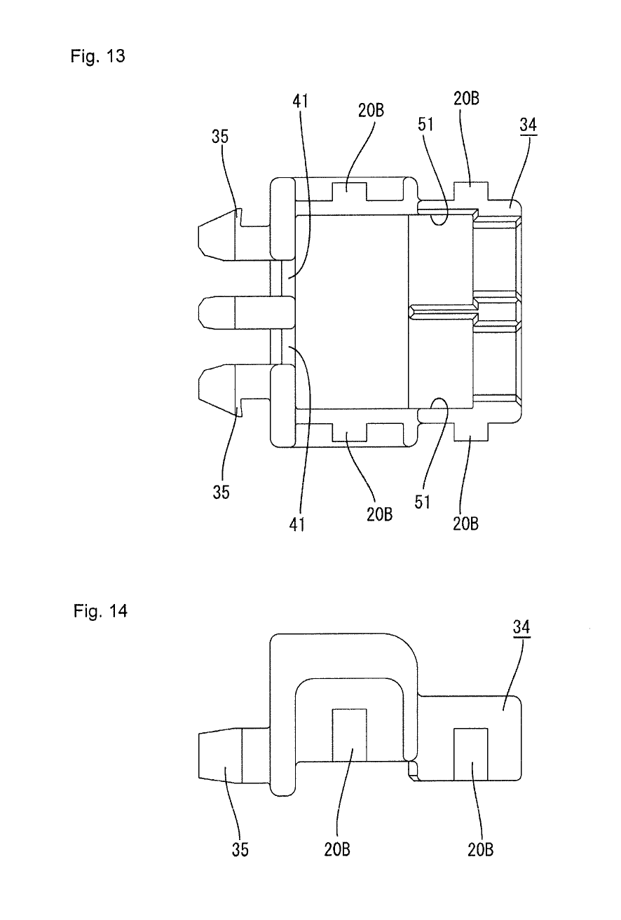

Also, as shown in FIG. 13, a lock claw 35 that projects forward (leftward in FIG. 13) is formed on the male-side upper housing 34. The male-side upper housing 34 and the front housing 32 are integrally attached by elastically engaging the lock claw 35 with a lock claw receiving portion (not shown) that is formed on the front housing 32.

As shown in FIG. 1, a lock arm 36 that extends rearward (rightward in FIG. 1) from the front end portion (left end portion in FIG. 1) is formed on the upper face of the front housing 32. A claw portion 37 that projects upward is formed at a position on the upper face of the lock arm 36 that is toward the back end portion. The female-side connector 13 and the male-side connector 11 can be held in the state of being mated together by elastically engaging the claw portion 37 with a claw receiving portion 50 that is formed inside the hood portion 12 of the female-side housing at a position that corresponds to the claw portion 37.

As shown in FIG. 1, a protective tube portion 38 that extends forward (leftward in FIG. 1) is formed in the front end portion (left end portion in FIG. 1) of the front housing 32. The ferrules 17A and 17B are arranged inside the protective tube portion 38. Also, the fitting tube portion 29 of the female-side connector 13 is fitted into the protective tube portion 38 when the male-side connector 11 and the female-side connector 13 are mated together.

A spring housing portion 40 that opens rearward (rightward in FIG. 1) and accommodates a coil spring 39 is formed in the back end portion (right end portion in FIG. 1) of the front housing 32. Also, a spring receiving portion 41 that comes into contact with the back end portion of the coil spring 39 from behind is formed so as to project inward in the front end portion (left end portion in FIG. 1) of the male-side upper housing 34.

The front end portion of the coil spring 39 is locked to the ferrule 17 from behind, and biases the ferrule 17 forward (leftward in FIG. 1).

The ferrule 17A accommodated in the male-side connector 11 is inserted into the sleeve 30 when the male-side connector 11 and the female-side connector 13 are mated together. The tip of the ferrule 17B accommodated in the female-side connector 13 and the tip of the ferrule 17A accommodated in the male-side connector 11 come into contact with each other inside the sleeve 30. Since the ferrule 17A is biased by the coil spring 39, the ferrule 17A is pressed against the ferrule 17B. Accordingly, the optical fiber 14 on the male-side connector 11 side and the optical fiber 14 on the female-side connector 13 side are optically connected.

Ferrule 17

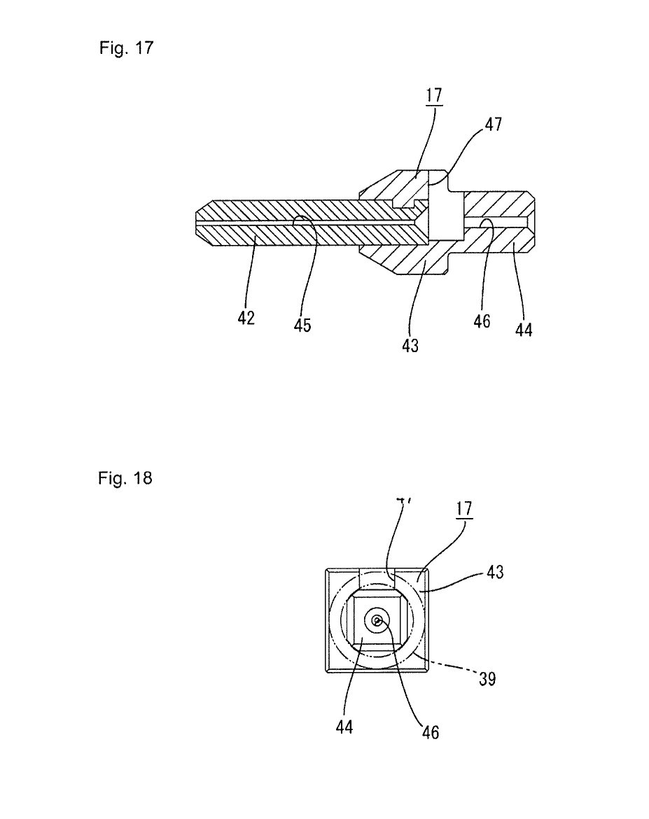

As shown in FIG. 17, the ferrule 17 includes a tubular capillary 42, a flange 43 formed on the back end portion of the capillary 42 by mold-formation using synthetic resin, and a shaft portion 44 that is formed so as to be integral with the flange 43, and extends from the flange 43, away from the tip of the ferrule 17 along the axial direction of the ferrule 17. The capillary 42 has a circular cross-section. A capillary-side insertion hole 45 that extends in the axial direction of the capillary 42 is formed in the capillary 42. The optical fiber 14 is inserted into the capillary-side insertion hole 45.

As shown in FIG. 18, the flange 43 is formed so as to project outward in the diameter direction of the ferrule 17. The flange 43 has a square outer shape. Among the outer faces of the flange 43, the outer face on the capillary 42 side has a tapered inclined face formed thereon.

As shown in FIG. 18, the shaft portion 44 has a regular polygonal cross-section. The regular polygonal shape includes the shape of a regular polygon having chamfered vertices. In other words, although a shape technically ceases to be a regular polygon if the vertices are chamfered, the present invention encompasses the case where such a shape is substantially accepted as being a regular polygon. This chamfering may be achieved with flat faces, or may be achieved with curved faces. In the present embodiment, the shaft portion 44 has a square cross-section. The shaft portion 44 therefore has a substantially rectangular parallelepiped shape overall. The ridge portion of the shaft portion 44 that extends in the lengthwise direction is chamfered. The chamfering of the ridge portion of the shaft portion 44 is achieved with curved faces. The above-described coil spring 39 is fitted around the shaft portion 44. The portions of the shaft portion 44 that correspond to the vertices of the cross section come into contact with the inner periphery of the coil spring 39 fitted around the shaft portion 44.

Note that in the present embodiment, the cross-sectional shape of the shaft portion 44 is the shape described in detail below. Specifically, the shape of a square whose vertices are chamfered with curved faces is formed by cutting four identically-shaped arches in one circle, using the center of the circle as the center of point symmetry.

A shaft portion-side insertion hole 46 is formed in the shaft portion 44 along the direction in which the shaft portion 44 extends. The optical fiber 14 is inserted into the shaft portion-side insertion hole 46. The above-described capillary-side insertion hole 45 and the shaft portion-side insertion hole 46 are formed coaxially.

Among the outer faces of the flange 43, the outer face on the shaft portion 44 side is formed so as to fall precipitously relative to the direction in which the shaft portion 44 extends. In the present embodiment, among the outer faces of the flange 43, the outer face on the shaft portion 44 side is formed so as to be substantially perpendicular to the direction in which the shaft portion 44 extends. Also, an injection hole 47 for the injection of an adhesive is formed so as to extend between the flange 43 and the shaft portion 44, along a direction that is orthogonal to the axis of the shaft portion 44. The optical fiber 14 is inserted into the capillary-side insertion hole 45 and the shaft portion-side insertion hole 46, and is fixed so as to be fitted around the ferrule 17 by injecting an adhesive into the injection hole 47 and allowing it to harden.

Structure for Disposing Ferrule 17B in Female-Side Connector 13

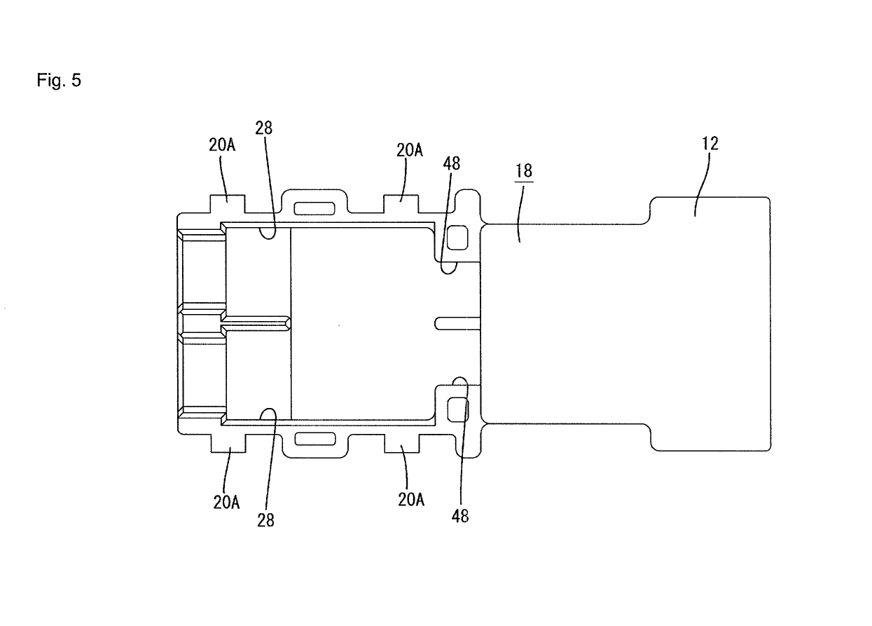

As shown in FIG. 1, a flange housing portion 48 that accommodates the flange 43 of the ferrule 17B is formed on the lower wall of the female-side connector 13. More specifically, as shown in FIG. 5, two flange housing portions 48, which are formed in the shape of a groove that opens upward, are formed on the female-side lower housing 18 so as to be aligned in the left-right direction (the up-down direction in FIG. 5). The inner faces of the flange housing portion 48 oppose the flange 43 when the ferrule 17 is accommodated in the flange housing portion 48, and are formed in a shape that mimics the outer shape of the flange 43. Specifically, the inner faces of the flange housing portion 48 have a substantially square shape.

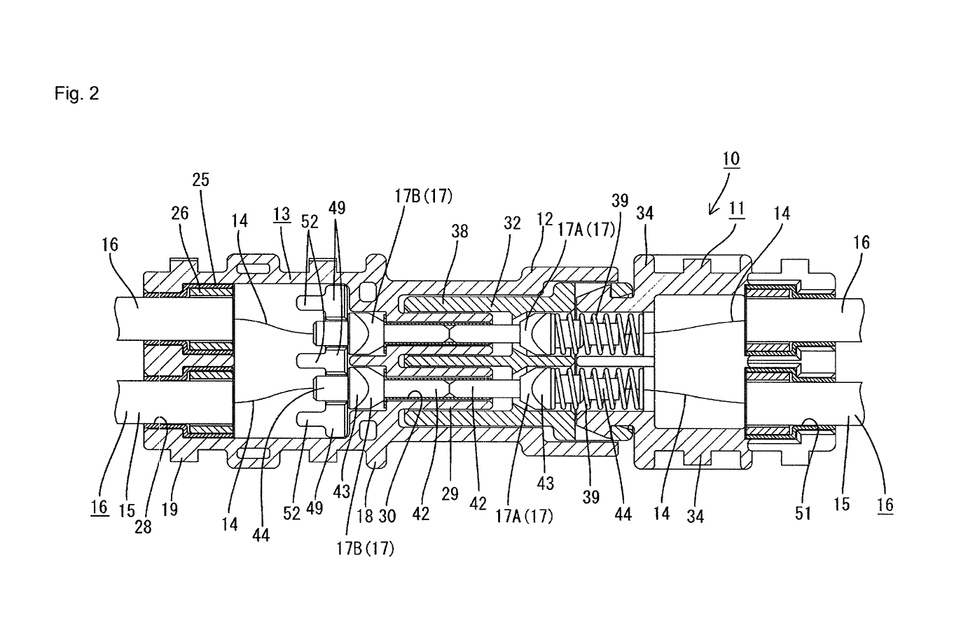

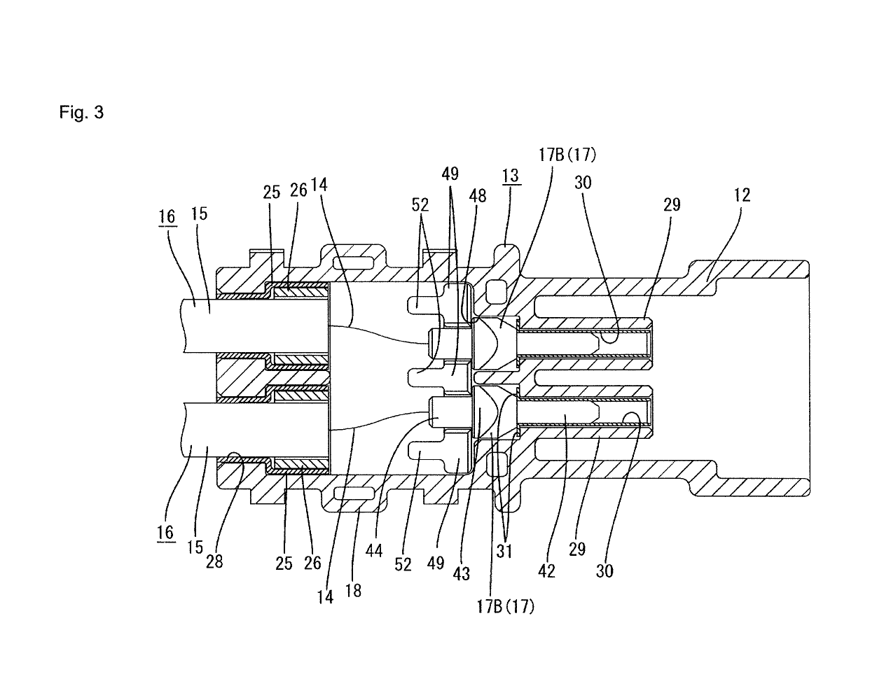

Also, as shown in FIG. 1, a flange receiving portion 49 (one example of a holding portion) that hangs downward is formed on the upper wall of the female-side upper housing 19. The flange receiving portion 49 comes into contact with the flange 43 from behind the flange 43 (leftward in FIG. 1) when the ferrule 17 is accommodated in the flange housing portion 48. In other words, the flange 43 comes into contact with the flange 43 from behind in the mating direction of the female-side connector 13. Accordingly, the ferrule 17B is restricted from moving rearward (leftward in FIG. 1) (see FIGS. 2 and 3).

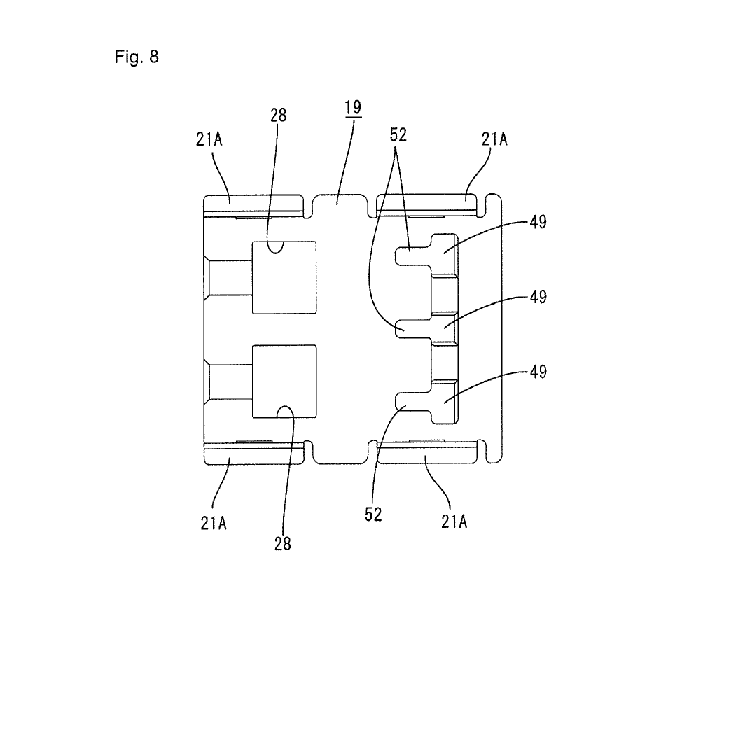

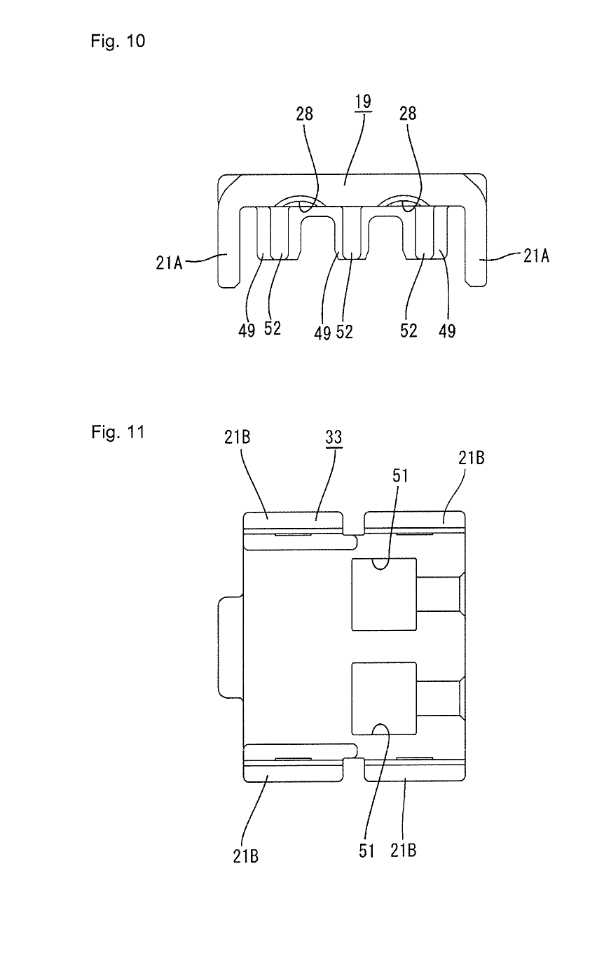

Also, as shown in FIG. 10, each flange receiving portion 49 is roughly gate-shaped. Accordingly, it comes into contact with the upper portion and two side portions of the flange 43 from behind. This reliably restricts rearward movement of the ferrule 17B. Furthermore, as shown in FIG. 8, ribs 52 that extend rearward (leftward in FIG. 8) are formed on the flange receiving portions 49. Even if the ferrule 17B is pressed from ahead (from the right in FIG. 8) by the ferrule 17A accommodated in the male-side connector 11, deformation of the flange receiving portion 49 can be reliably suppressed by these ribs 52 (see FIGS. 2 and 3).

A portion of each flange receiving portion 49 that opposes the shaft portion 44 is formed so as to mimic the outer shape of the shaft portion 44. In the present embodiment, the portion of each flange receiving portion 49 that opposes the shaft portion 44 is formed so as to be substantially quadrangular. This makes it possible for the shaft portion 44 to be easily positioned.

Structure for Disposing Ferrule 17A in Male-Side Connector 11

As shown in FIG. 18, when the coil spring 39 is fitted around the shaft portion 44, the portion of the coil spring 39 projected on the flange 43 portion is smaller than the flange 43 portion. In other words, the coil spring 39 is reliably received by the flange 43 portion when pressed against the flange 43.

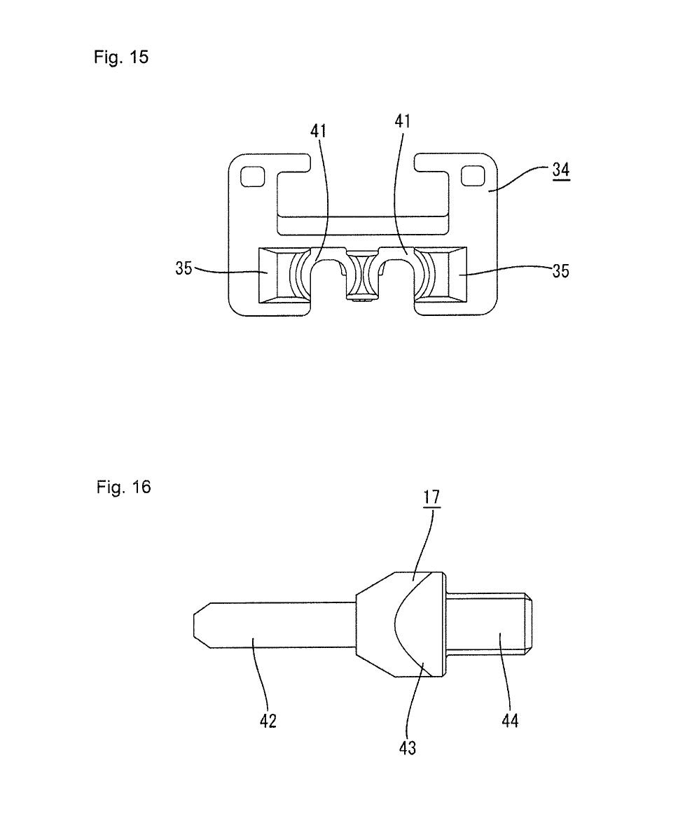

As shown in FIG. 1, the back end portion (right end portion in FIG. 1) of the coil spring 39 is received by the above-described spring receiving portion 41. In other words, the coil spring 39 is held by the spring receiving portion 41 from behind in the mating direction of the male-side connector 11. As shown in FIG. 15, the spring receiving portion 41 is formed so as to hang downward from the upper wall of the male-side upper housing 34. The spring receiving portion 41 is roughly gate-shaped. The portion of the spring receiving portion 41 that comes into contact with the coil spring 39 is shaped as a circle so as to mimic the shape of the coil spring 39. Also, the portion of the spring receiving portion 41 that opposes the shaft portion 44 of the ferrule 17A is formed so as to be substantially shaped as a quadrangle having a rounded upper portion, so as to mimic the outer shape of the shaft portion 44.

As shown in FIG. 1, the spring housing portion 40 that accommodates the coil spring 39 is formed in a shape that mimics the outer shape of the coil spring 39. This suppresses movement of the coil spring 39 in a direction that is orthogonal to the axis of the coil spring 39.

### Actions and Effects of Embodiment

Next, actions and effects of the present embodiment will be described. According to the present embodiment, the ferrule 17B is held such that rearward movement is restricted due to the flange receiving portion 49, which is formed on the female-side upper housing 19, coming into contact with the ferrule 17B from behind (the left in FIGS. 1 and 2) in the female-side connector 13. Also, the front portion of the flange 43 comes into contact with the back wall of the hood portion 12, which is formed on the female-side lower housing 18, from behind (the left in FIGS. 1 and 2). Forward (rightward in FIGS. 1 and 2) movement of the ferrule 17B is thus restricted. In this way, the ferrule 17B is reliably held in the female-side connector 13. This eliminates the need for the coil spring 39 for locking the ferrule 17B in the female-side connector 13. As a result, area for ensuring the stroke of the coil spring 39 is unnecessary, thus making it possible to reduce the size of the female-side connector 13. This enables reducing the size of the optical connector 10 as a whole.

Also, the shaft portion 44 has a regular polygonal cross-section. For this reason, the surface area of the shaft portion 44 projected on the flange 43 is smaller than that in the case where the shaft portion 44 has a circular cross-section. This enables increasing the area of engagement between the flange 43 and the flange receiving portion 49. Since the portion of the flange receiving portion 49 that opposes the shaft portion 44 is formed so as to mimic the outer shape of the shaft portion 44, the area of the shaft portion 44 where the surface area thereof projected on the flange 43 is smaller can be reliably used as an engagement area. As a result, the ferrule 17B can be reliably held in the female-side connector 13.

On the other hand, the vertices in the cross section of the shaft portion 44 of the ferrule 17A form a regular polygonal shape that comes into contact with the inner periphery of the coil spring 39. For this reason, when the ferrule 17A is locked by the coil spring 39 in the male-side connector 11, the axis of the coil spring 39 and the axis of the shaft portion 44 can be aligned. This enables causing the axis of the ferrule 17A and the axis of the coil spring 39 to conform to each other. As a result, it is possible to hold the ferrule 17A at the correct position, thus making it possible to reliably maintain the optical connection between the optical fiber 14 attached to the male-side connector 11 and the optical fiber 14 attached to the female-side connector 13.

Note that the regular polygonal shape includes a shape obtained by performing chamfer work on the vertices of a regular polygon. In other words, although a shape technically ceases to be a regular polygon if the vertices are subjected to chamfer work, the present invention encompasses the case where such a shape is substantially accepted as being a regular polygon. This chamfer work may be achieved with flat faces, or may be achieved with curved faces.

Also, according to the present embodiment, the sleeve 30 in to which the ferrules 17A and 17B are inserted is accommodated in the female-side connector 13. Accordingly, when the male-side connector 11 and the female-side connector 13 are mated together, the ferrule 17A accommodated in the male-side connector 11 and the ferrule 17B accommodated in the female-side connector 13 are inserted into the sleeve 30 accommodated in the female-side connector 13. The tip of the ferrule 17A accommodated in the male-side connector 11 and the tip of the ferrule 17B accommodated in the female-side connector 13 then come into contact with each other. Since both of the ferrules 17A and 17B are guided by the inner face of the sleeve 30, the axes of both of the ferrules 17A and 17B can be reliably aligned. As a result, the optical fiber 14 attached to the male-side connector 11 and the optical fiber 14 attached to the female-side connector 13 can be reliably optically connected.

When the tips of both of the ferrules 17A and 17B come into contact, the ferrule 17A accommodated in the male-side connector 11 retreats due to being pressed by the ferrule 17B accommodated in the female-side connector 13. However, such the ferrule 17A is pressed by the coil spring 39, the ferrule 17A and the ferrule 17B reliably come into contact.

Also, according to the present embodiment, the flange housing portion 48 that accommodates the flange 43 of the ferrule 17 is formed in the female-side connector 13, and the face of the flange housing portion 48 that opposes the flange 43 is formed so as to mimic the outer shape of the flange 43. Accordingly, the flange 43 of the ferrule 17 needs only be accommodated in the flange housing portion 48 formed in a shape that mimics the outer shape of the flange 43, thus making it possible to easily hold the orientation of the flange 43 at the correct position when the flange 43 is accommodated in the flange housing portion 48.

### Embodiment 2

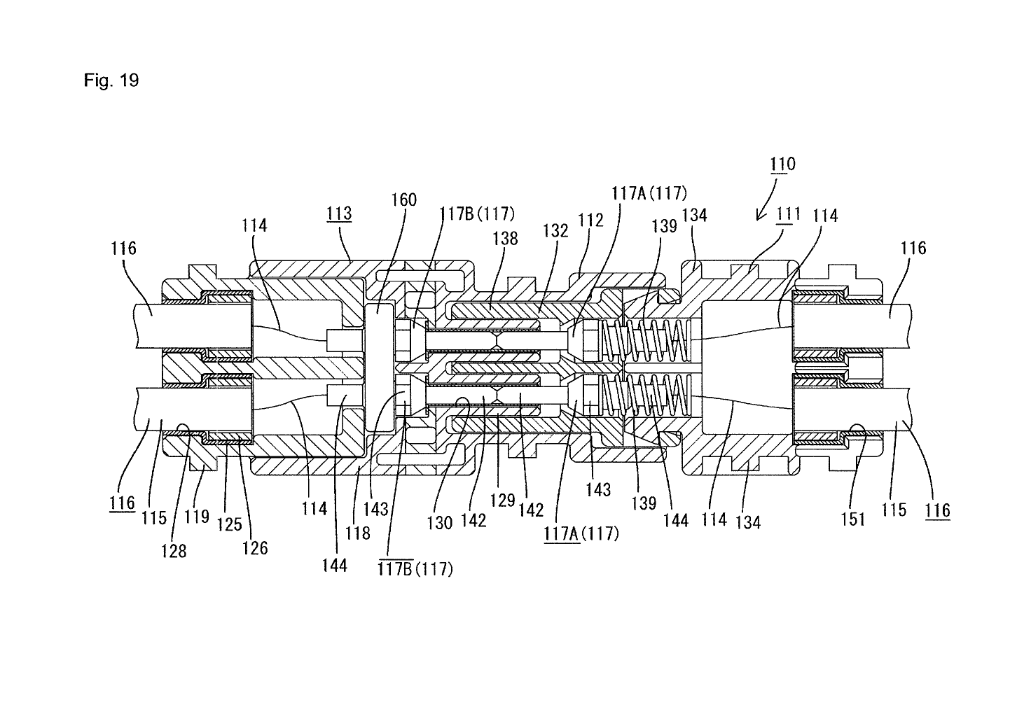

The following describes Embodiment 2 of the present invention with reference to FIGS. 19 to 27. An optical connector 110 of the present embodiment includes a male-side connector 111 (first connector) and a female-side connector 113 (second connector) that includes a hood portion 112 into which the male-side connector 111 is fitted. The male-side connector 111 and the female-side connector 113 are each attached to the end portion of an optical cord 116 configured by an optical fiber 114 whose outer periphery is enclosed in a sheath 115. In the end portions of the optical cords 116 located on the sides where the male-side connector 111 and the female-side connector 113 are attached, ferrules 117A and 117B are fixed to the tips of the optical fibers 114, which are exposed from the sheath 115 due to the sheath 115 being peeled back. The ferrule 117A is accommodated in the male-side connector 111, and the ferrule 117B is accommodated in the female-side connector 113. The ferrules 117A and 117B have the same shape and size, and are shared between the male-side connector 111 and the female-side connector 113.

Note that the collective term “ferrule 117” will be used in the following description when describing structures that are common to the ferrules 117A and 117B.

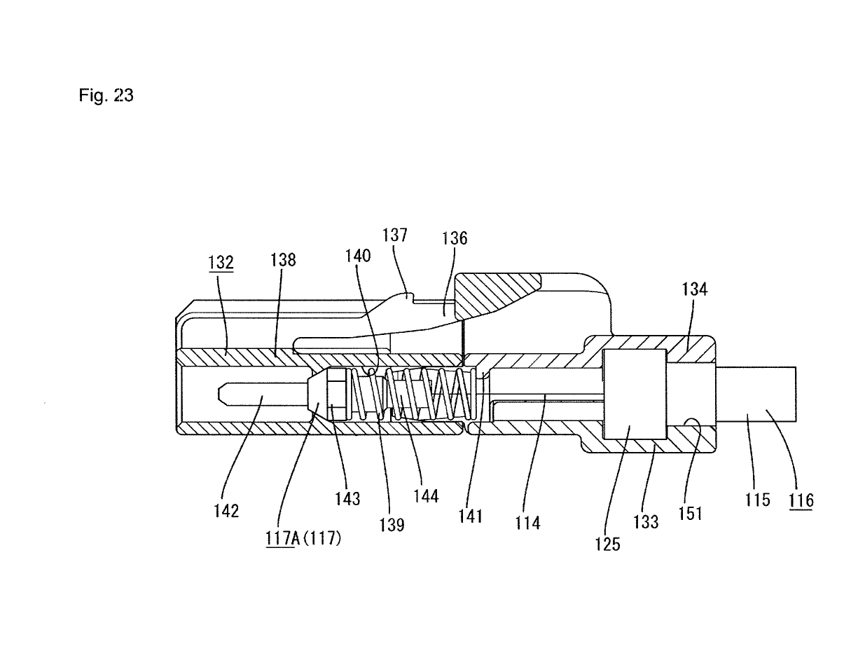

Also, in the following description, “upward” refers to the upward direction in FIG. 23, and “downward” refers to the downward direction in FIG. 23. Also, regarding the forward and backward directions, “forward” refers to the forward direction in the mating direction of the connectors 111 and 113, and “backward” refers to the backward direction in the mating direction. Accordingly, the forward and backward directions in the male-side connector 111 are oriented oppositely to the forward and backward directions in the female-side connector 113.

Female-Side Connector 113

The female-side connector 113 includes a female-side lower housing 118 that is made of synthetic resin and includes a hood portion 112 that is open forward in the mating direction (rightward in FIG. 19), and a female-side upper housing 119 that is made of synthetic resin and attached to the female-side lower housing 118 from above. The female-side lower housing 118 and the female-side upper housing 119 are integrally attached to each other by elastically engaging a lock projection portion (not shown) and a lock receiving portion (not shown).

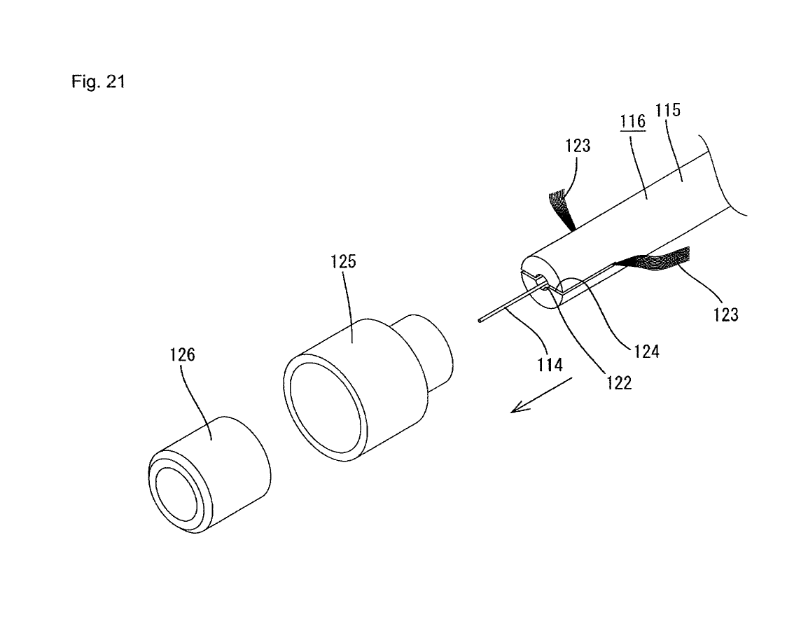

The female-side connector 113 internally accommodates the optical cord 116, the optical fiber 114 exposed from the end portion of the optical cord 116, and the ferrule 117B fixed so as to be fitted around the tip of the optical fiber 114. As shown in FIG. 21, a through-hole 122 that extends in the axial direction of the optical cord 116 is formed in the sheath 115 of the optical cord 116. One optical fiber 114 is inserted into this through-hole 122. A tensile force resisting member 123 is accommodated between the optical fiber 114 and the sheath 115 so as to suppress disconnection of the optical fiber 114 when tensile force is applied to the optical cord 116. The tensile force resisting member 123 is fibrous. A slit 124 that extends in the axial direction of the optical cord 116 is formed in the end portion of the sheath 115. The tensile force resisting member 123 is drawn out of the slit 124, the tensile force resisting member 123 is arranged between a metal outer ring 125 and a metal inner ring 126, and the outer ring 125 is swaged to the inner ring 126, thus clamping the tensile force resisting member 123 between the outer ring 125 and the inner ring 126. Also, the sheath 115 is fixed due to the outer ring 125 being fitted around the sheath 115 and then swaged to the sheath 115.

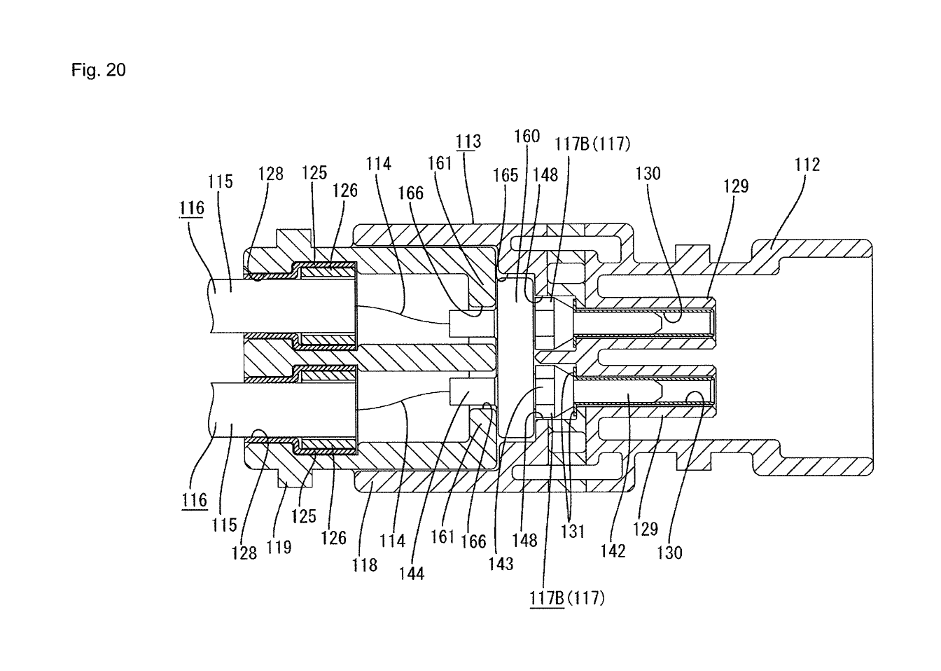

An outer ring housing groove 128 that accommodates the outer ring 125 is formed so as to extend in the forward-backward direction (left-right direction in FIG. 20) at a position toward the back end portion (position toward the left end portion in FIG. 20) of the female-side lower housing 118 and the female-side upper housing 119.

A fitting tube portion 129 is formed inside the hood portion 112 so as to project forward in the mating direction (rightward in FIG. 20) of the female-side connector 113. A sleeve 130, into which the ferrules 117 are inserted, is accommodated inside the fitting tube portion 129. The ferrule 117A and the ferrule 117B are both accommodated inside the sleeve 130. The sleeve 130 is substantially tubular, and is formed from a material capable of elastic deformation in the diameter direction, such as a metal or a ceramic. A pair of locking pieces 131 that project outward in the diameter direction of the sleeve 130 are formed on the back end portion (left end portion in FIG. 20) of the sleeve 130. The sleeve 130 is restricted from moving forward (rightward in FIG. 20) due to the locking pieces 131 coming into contact with the back wall of the hood portion 112 from behind (from the left in FIG. 20).

Due to the ferrule 117B being arranged inside the fitting tube portion 129, collision of the ferrule 117B with a foreign object is suppressed. Also, even if the male-side connector 111 is fitted into the hood portion 112 in an inclined manner, collision between the tip of the male-side connector 111 and the ferrule 117B is suppressed.

Male-Side Connector 111

As shown in FIG. 19, the male-side connector ill includes a front housing 132 that is made of synthetic resin and fitted into the hood portion 112, a male-side lower housing 133 that is made of synthetic resin and attached rearward (rightward in FIG. 19) of the front housing 132, and a male-side upper housing 134 that is made of synthetic resin, arranged rearward of the front housing 132, and attached to the upper side of the male-side lower housing 133.

The male-side connector 111 internally accommodates an optical cord 116, an optical fiber 114 exposed from the end portion of the optical cord 116, and a ferrule 117A fixed so as to be fitted around the tip of the optical fiber 114. An inner ring 126 and an outer ring 125 are attached to the end of the optical fiber 114. The optical fiber 114, the ferrule 117A, the inner ring 126, and the outer ring 125 have the same configurations as the corresponding members accommodated in the female-side connector 113, and therefore redundant descriptions will not be given for them.

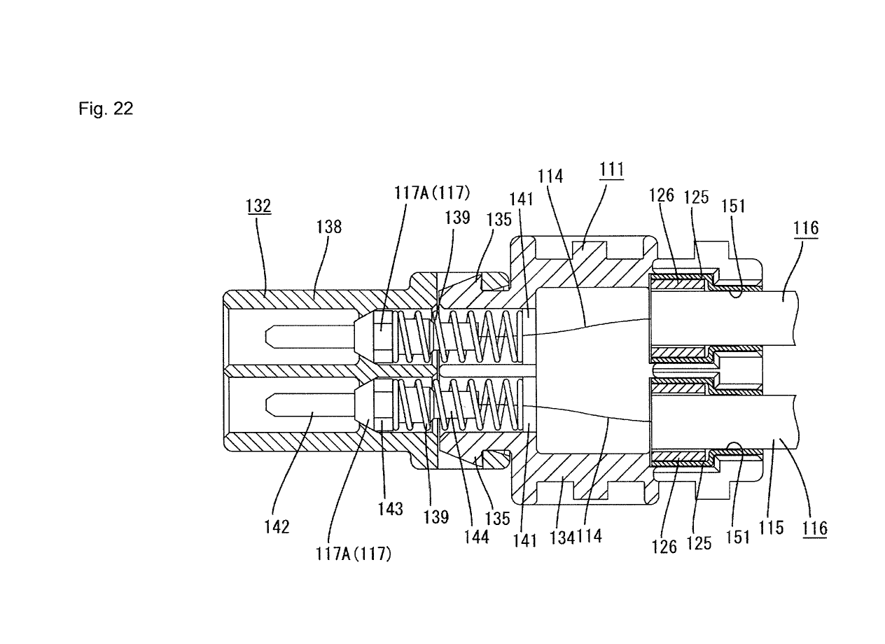

An outer ring housing groove 151 that accommodates the outer ring 125 is formed so as to extend in the forward-backward direction (left-right direction in FIG. 22) at a position toward the back end portion (position toward the right end portion in FIG. 22) of the male-side lower housing 133 and the male-side upper housing 134.

The male-side upper housing 134 and the male-side lower housing 133 are integrally attached to each other by elastically engaging a lock projection portion (not shown) and a lock receiving portion (not shown).

Also, as shown in FIG. 22, a lock claw 135 that projects forward (leftward in FIG. 22) is formed on the male-side upper housing 134. The male-side upper housing 134 and the front housing 132 are integrally attached by elastically engaging the lock claw 135 with a lock claw receiving portion (not shown) that is formed on the front housing 132.

As shown in FIG. 23, a lock arm 136 that extends rearward (rightward in FIG. 23) from the front end portion (left end portion in FIG. 23) is formed on the upper face of the front housing 132. A claw portion 137 that projects upward is formed at a position on the upper face of the lock arm 136 that is toward the back end portion. The female-side connector 113 and the male-side connector 111 can be held in the state of being mated together by elastically engaging the claw portion 137 with a claw receiving portion (not shown) that is formed inside the hood portion 112 of the female-side housing at a position that corresponds to the claw portion 137.

As shown in FIG. 22, a protective tube portion 138 that extends forward (leftward in FIG. 22) is formed in the front end portion (left end portion in FIG. 22) of the front housing 132. The ferrule 117A is arranged inside the protective tube portion 138. Also, the fitting tube portion 129 of the female-side connector 113 is fitted into the protective tube portion 138 when the male-side connector 111 and the female-side connector 113 are mated together.

Due to the ferrule 117A being arranged inside the protective tube portion 138, collision of the ferrule 117A with a foreign object is suppressed. Also, it is possible to suppress the collision of the ferrule 117A with the inner walls of the hood portion 112 when the male-side connector 111 is fitted into the hood portion 112 of the female-side connector 113.

A spring housing portion 140 that opens rearward (rightward in FIG. 22) and accommodates a coil spring 139 is formed in the back end portion (right end portion in FIG. 22) of the front housing 132. Also, a spring receiving portion 141 that comes into contact with the back end portion of the coil spring 139 from behind is formed so as to project inward in the front end portion (left end portion in FIG. 19) of the male-side upper housing 134.

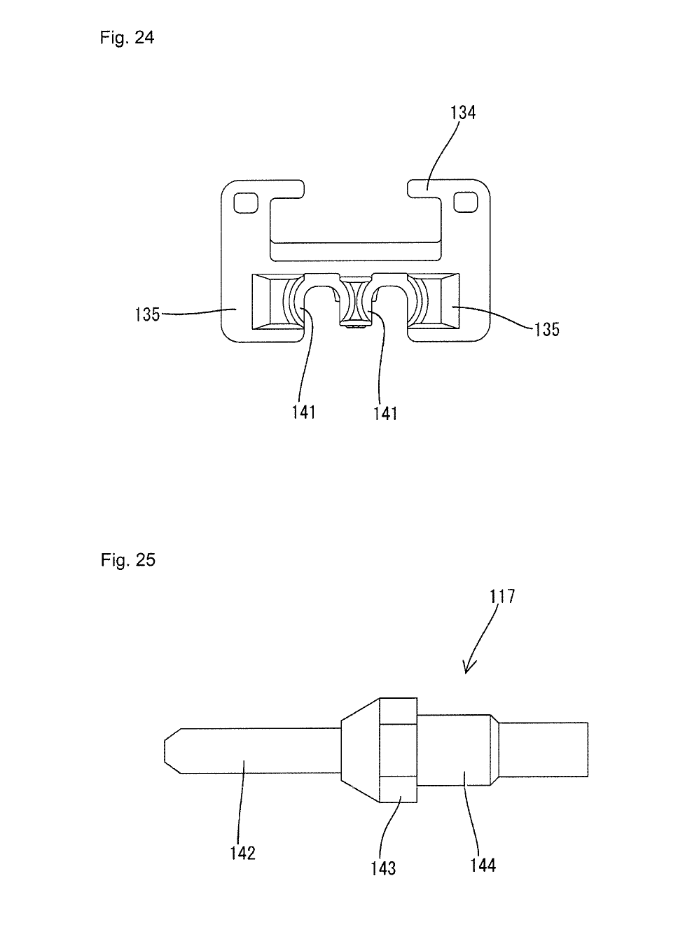

As shown in FIG. 24, the spring receiving portion 141 is formed so as to hang downward from the upper wall of the male-side upper housing 134. The spring receiving portion 141 is roughly gate-shaped. The portion of the spring receiving portion 141 that comes into contact with the coil spring 139 is shaped as a circle so as to mimic the shape of the coil spring 139.

The front end portion of the coil spring 139 is locked to the ferrule 117 from behind, and biases the ferrule 117 forward (leftward in FIG. 22).

As shown in FIG. 19, the ferrule 117A accommodated in the male-side connector 111 is inserted into the sleeve 130 when the male-side connector 111 and the female-side connector 113 are mated together. The tip of the ferrule 117B accommodated in the female-side connector 113 and the tip of the ferrule 117A accommodated in the male-side connector 111 come into contact with each other inside the sleeve 130. Since the ferrule 117A is biased by the coil spring 139, the ferrule 117A is pressed against the ferrule 117B. Accordingly, the optical fiber 114 on the male-side connector 111 side and the optical fiber 114 on the female-side connector 113 side are optically connected.

Ferrule 117

As shown in FIG. 25, the ferrule 117 includes a tubular capillary 142, a flange 143 formed on the back end portion of the capillary 142 by mold-formation using synthetic resin, and a shaft portion 144 that is formed so as to be integral with the flange 143, and extends from the flange 143, away from the tip of the ferrule 117 along the axial direction of the ferrule 117. The capillary 142 has a circular cross-section. A capillary-side insertion hole (not shown) that extends in the axial direction of the capillary 142 is formed in the capillary 142. The optical fiber 114 is inserted into the capillary-side insertion hole.

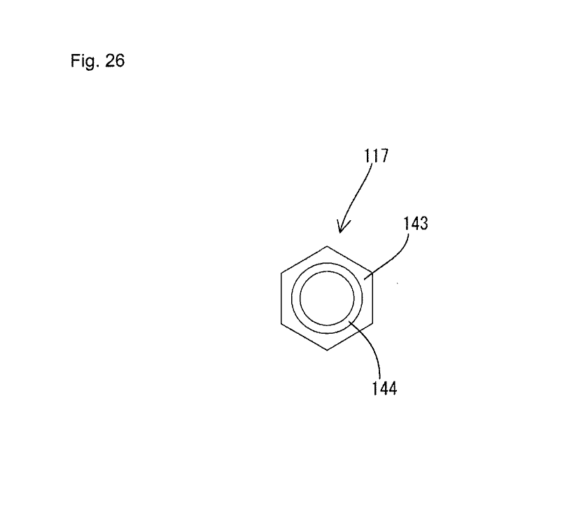

As shown in FIG. 26, the flange 143 is formed so as to project outward in the diameter direction of the ferrule 117. The flange 143 has a regular hexagonal outer shape. Among the outer faces of the flange 143, the outer face on the capillary 142 side has a tapered inclined face formed thereon.

As shown in FIG. 25, the back end portion (right end portion in FIG. 25) of the shaft portion 144 has a decreasing diameter. The outer diameter dimension of the front end portion of the shaft portion 144 is set so as to be substantially the same as the inner diameter dimension of the coil spring 139. Accordingly, the shaft portion 144 comes into contact with the inner periphery of the coil spring 139 that is fitted around the shaft portion 144.

A shaft portion-side insertion hole (not shown) is formed in the shaft portion 144, along the direction in which the shaft portion 144 extends. The optical fiber 114 is inserted into the shaft portion-side insertion hole. The above-described capillary-side insertion hole and the shaft portion-side insertion hole are formed coaxially.

Structure for Protecting Ferrule 117B in Female-Side Connector 113

As shown in FIG. 20, a flange housing portion 148 that accommodates the flange 143 of the ferrule 117B is formed on the female-side lower housing 118.

Rearward (leftward in FIG. 20) of the flange housing portion 148, the female-side lower housing 118 includes a locking member housing portion 165 that accommodates a locking member 160 (one example of a holding portion) for locking with the ferrule 117B.

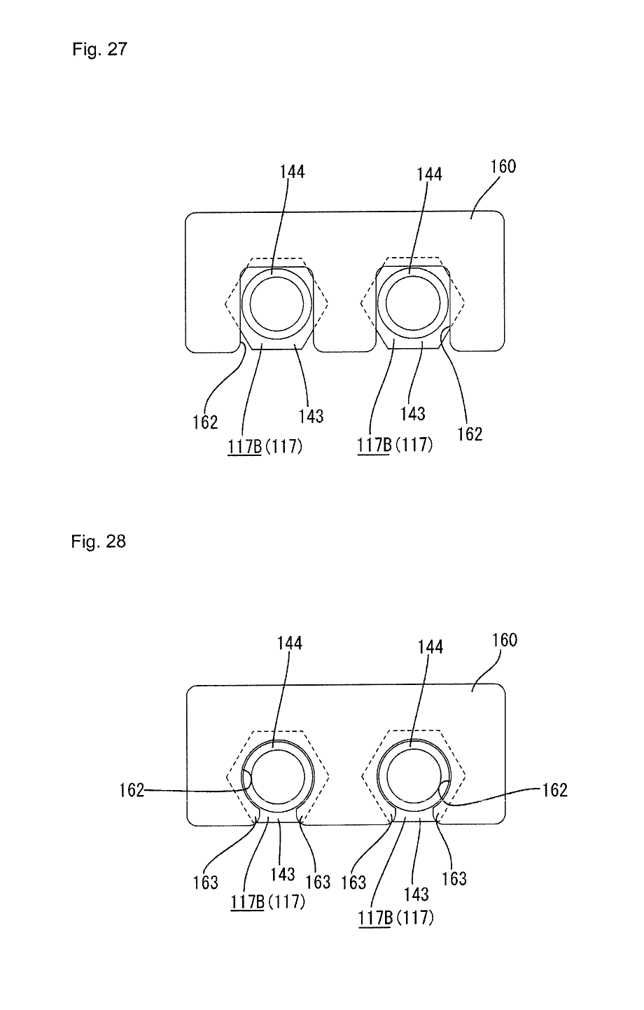

The locking member 160 is made of synthetic resin and is plate-shaped. As shown in FIG. 27, a shaft portion housing groove 162 that accommodates the shaft portion 144 of the ferrule 117B is formed in the locking member 160 so as to open downward. In the present embodiment, two shaft portion housing grooves 162 are formed alongside each other. The faces of the shaft portion housing grooves 162 that oppose the shaft portions 144 are formed so as to be substantially rectangular. The locking member 160 is formed so as to be larger than the flange 143 in terms of the diameter direction of the ferrule 117B.

As shown in FIG. 20, rearward movement of the locking member 160 is restricted due to the front end portion of the female-side upper housing 119 coming into contact with the locking member 160 from behind (the left in FIG. 20) in the mating direction of the female-side connector 113. The front end portion of the female-side upper housing 119 is used as a locking member receiving portion 161. Insertion holes 166 for the insertion of shaft portions are formed in the locking member receiving portion 161 so as to pierce the shaft portion of the locking member 160.

### Actions and Effects of Embodiment

According to the present embodiment, the ferrule 117B is reliably held in the female-side connector 113 by the locking member receiving portion 161 via the locking member 160. Moreover, since the locking member 160 is formed so as to be larger than the flange 143 with respect to the diameter direction of the ferrule 117B, the ferrule 117B can be reliably held in the female-side connector 113.

Also, since the locking member 160 is formed so as to be larger in comparison to the flange 143, there is no need to raise dimensional precision for the female-side connector 113 in order to form the area for engagement with the flange 143, thus making it possible to suppress a rise in the manufacturing cost of the optical connector 110.

Also, since the coil spring 139 can be omitted from the female-side connector 113, there is no need to ensure the stroke of the coil spring 139. This enables reducing the size of the female-side connector 113 and enables reducing the size of the optical connector 110 as a whole.

Also, according to the present embodiment, it is possible to lock the ferrule 117B and the locking member 160 with a simple configuration in which the shaft portion 144 is accommodated in the shaft portion housing groove 162.

### Embodiment 3

Next, Embodiment 3 of the present invention will be described with reference to FIG. 28. In the present embodiment, the locking member 160 is formed such that a pair of opening edge portions 163 of each shaft portion housing groove 162 can deform so as to spread open. The pair of opening edge portions 163 are formed such that the interval between them in their natural state is smaller than the outer diameter dimension of the shaft portion. Also, the faces of the shaft portion housing grooves 162 that oppose the shaft portions 144 are formed in a circular shape so as to mimic the outer shape of the shaft portions 144.

Configurations other than those described above are substantially the same as those in Embodiment 2, and therefore like members will be denoted by like reference signs, and redundant descriptions will not be given for them.

According to the present embodiment, when the shaft portions 144 are to be accommodated in the shaft portion housing grooves 162, first, the shaft portions 144 are pressed into the pair of opening edge portions 163 of the shaft portion housing groove 162. The pair of opening edge portions 163 then deform so as to spread open. When the shaft portions 144 are pressed further, the shaft portions 144 pass through the opening edge portions 163 that deformed so as to spread open, and enter the interior of the shaft portion housing grooves 162. As the shaft portions 144 enter farther into the shaft portion housing grooves 162, the pair of opening edge portions 163 deform so as to return to their natural state, and the shaft portions 144 are held inside the shaft portion housing grooves 162. In this way, according to the present embodiment, the shaft portions 144 can be reliably held by the locking member 160.

Also, according to the present embodiment, the faces of the shaft portion housing grooves 162 that oppose the shaft portions 144 are formed so as to mimic the outer shape of the shaft portions 144. This enables increasing the surface area where the flange 143 and the locking member 160 come into contact. Accordingly, it is possible for the ferrule 117B to be reliably held by the female-side connector 113 via the locking member 160.

### Embodiment 4

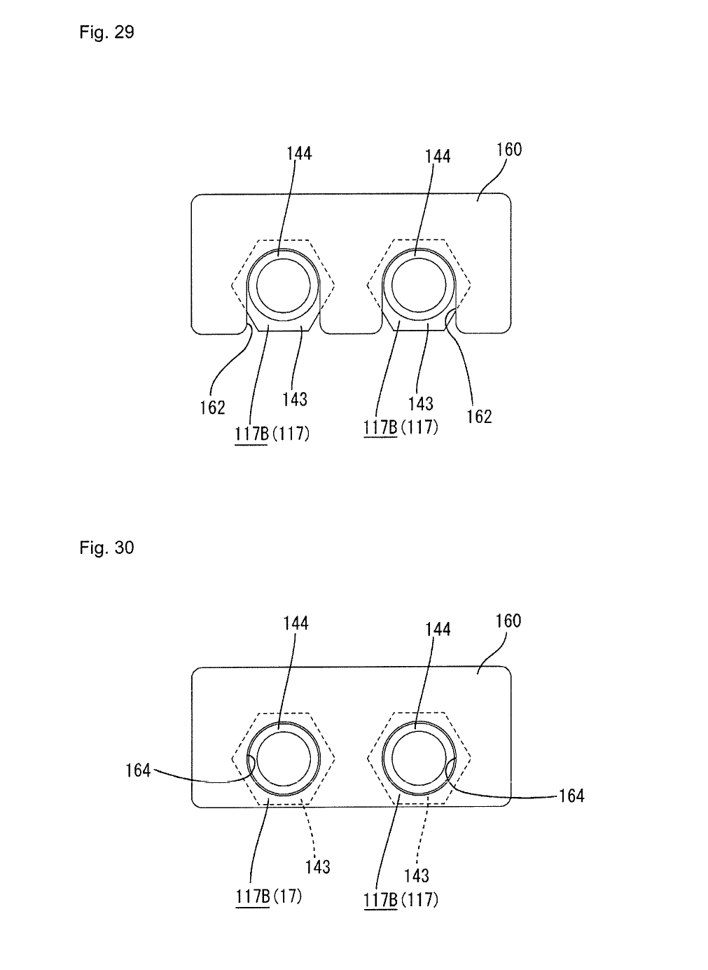

Next, Embodiment 4 of the present invention will be described with reference to FIG. 29. In the present embodiment, the faces of the shaft portion housing grooves 162 that oppose the shaft portions are formed in the shape of a semicircle that conforms to the outer shape of the shaft portions.

Configurations other than that described above are substantially the same as those in Embodiment 2, and therefore like members will be denoted by like reference signs, and redundant descriptions will not be given for them.

According to the above-described configuration, the surface area where the flange 143 and the locking member 160 come into contact can be increased. Accordingly, it is possible for the ferrule 117B to be reliably held by the female-side connector 113 via the locking member 160.

### Embodiment 5

Next, Embodiment 5 of the present invention will be described with reference to FIG. 30. In the present embodiment, shaft portion insertion holes 164 for the insertion of shaft portions are formed in the locking member 160 so as to pierce the locking member 160. The inner diameter dimension of the shaft portion insertion holes 164 is set so as to be the same as or somewhat larger than the outer diameter dimension of the shaft portions.

In the present embodiment, the ferrule 117B and the optical fiber 114 can be fixed by inserting the shaft portions 144 into the shaft portion insertion holes 164 and then inserting the optical fiber 114 into the ferrule 117B.

Configurations other than those described above are substantially the same as those in Embodiment 2, and therefore like members will be denoted by like reference signs, and redundant descriptions will not be given for them.

According to the present embodiment, the surface area where the flange 143 and the locking member 160 come into contact can be increased. Accordingly, it is possible for the ferrule 117B to be reliably held by the female-side connector 113 via the locking member 160.

### Other Embodiments

The present invention is not limited to the embodiments described by way of the above descriptions and figures, and embodiments such as the following are also encompassed in the technical scope of the present invention.

(1) Although the cross-sectional shape of the shaft portion 44 is square in Embodiment 1, the present invention is not limited to this. Any regular polygon can be used as necessary, such as a regular triangle, a regular pentagon, or a regular hexagon.

(2) Although one optical fiber 14 is arranged in one optical cord 16 in the configuration of Embodiment 1, the present invention is not limited to this. A configuration is possible in which two or more optical fibers 14 are arranged in one optical cord 16.

(3) Although the sleeve 30 is accommodated in the female-side connector 13 in the configuration of Embodiment 1, the sleeve 30 may be omitted.

(4) Although two ferrules are accommodated in both the male-side connector 11 and the female-side connector 13 in the configuration of Embodiment 1, the present invention is not limited to this. A configuration is possible in which one or three or more ferrules 17 are accommodated.

(5) Although one optical fiber 114 is arranged in one optical cord 116 in the configurations of Embodiments 2 to 5, the present invention is not limited to this. A configuration is possible in which two or more optical fibers 114 are arranged in one optical cord 116.

(6) Although the sleeve 130 is accommodated in the female-side connector 113 in the configurations of Embodiments 2 to 5, the sleeve 130 may be omitted.

(7) Although two ferrules 117 are accommodated in both the male-side connector 111 and the female-side connector 113 in the configuration of Embodiments 2 to 5, the present invention is not limited to this. A configuration is possible in which one or three or more ferrules 117 are accommodated.

### REFERENCE SIGNS LIST

10 Optical connector
11 Male-side connector (first connector)
13 Female-side connector (second connector)
14 Optical fiber
15 Sheath
16 Optical cord
17 Ferrule
30 Sleeve
39 Coil spring
41 Spring receiving portion
43 Flange
44 Shaft portion
48 Flange housing portion
49 Flange receiving portion
110 Optical connector
111 Male-side connector (first connector)
113 Female-side connector (second connector)
114 Optical fiber
115 Sheath
116 Optical cord
117 Ferrule
130 Sleeve
139 Coil spring
141 Spring receiving portion
143 Flange
144 Shaft portion
160 Locking member
161 Locking member receiving portion
162 Shaft portion housing groove
163 Opening edge portion
164 Shaft portion insertion hole

1. An optical connector comprises a first connector and a second connector that are mated to each other, the first connector and the second connector each being attached to an end portion of an optical cord configured by an optical fiber whose outer periphery is enclosed in a sheath, a first ferrule and a second ferrule respectively accommodated in the first connector and the second connector being fixed to a tip of the optical fiber that is exposed from the sheath, wherein
the first and second ferrules each comprises a flange that projects outward in a diameter direction of the ferrule, and a shaft portion that extends from the flange, away from a tip of the ferrule along an axial direction of the ferrule,
the first connector comprises a coil spring fitted around the shaft portion of the first ferrule and biasing the first ferrule forward in a mating direction of the first connector, and a spring receiving portion that holds the coil spring from behind in the mating direction of the first connector, and
the second connector comprises a holding portion that holds the second ferrule.

2. The optical connector according to claim 1,
wherein a cross-sectional shape of the shaft portion of the first ferrule is a regular polygonal shape in which vertices of a cross section of the shaft portion come into contact with an inner periphery of the coil spring, and
the holding portion is a flange receiving portion that is formed in the second connector and comes into contact with the flange of the second ferrule from behind in a mating direction of the second connector, and a portion of the flange receiving portion that opposes the shaft portion of the second ferrule is formed so as to correspond to an outer shape of the shaft portion.

3. The optical connector according to claim 1, wherein a sleeve configured for insertion of both the first ferrule accommodated in the first connector and the second ferrule accommodated in the second connector, is accommodated in the second connector.

4. The optical connector according to claim 1, wherein a flange housing portion that houses the flange of the second ferrule is formed in the second connector, and a face of the flange housing portion that opposes the flange of the second ferrule is formed so as to correspond to an outer shape of the flange.

5. The optical connector according to claim 1,
wherein the holding portion is a locking member formed as a separate member from the second connector and is formed so as to be locked to the shaft portion of the second ferrule and be larger than the flange of the second ferrule with respect to the diameter direction of the ferrule, and
the second connector comprises a locking member receiving portion that comes into contact with the locking member from behind in a mating direction of the second connector.

6. The optical connector according to claim 5, wherein a shaft portion housing groove for accommodating the shaft portion of the second ferrule is formed in the locking member.

7. The optical connector according to claim 6, wherein the locking member is formed such that a pair of opening edge portions of the shaft portion housing groove can deform so as to spread open, and is formed such that an interval between the pair of opening edge portions is smaller than an outer diameter dimension of the shaft portion of the second ferrule in a natural state.

8. The optical connector according to claim 6, wherein a face of the shaft portion housing groove that opposes the shaft portion of the second ferrule is formed so as to correspond to an outer shape of the shaft portion.

9. The optical connector according to claim 5, wherein a shaft portion insertion hole for insertion of the shaft portion of the second ferrule is formed in the locking member so as to pierce the locking member.

10. A ferrule configured to be fitted around and fixed to a terminal of an optical fiber, the ferrule including a shaft portion around which a coil spring is fitted, extending in an axial direction of the ferrule, a cross-sectional shape of the shaft portion being a regular polygonal shape in which vertices of a cross section of the shaft portion come into contact with an inner periphery of the coil spring.

11. The optical connector according to claim 2, wherein a sleeve configured for insertion of both the first ferrule accommodated in the first connector and the second ferrule accommodated in the second connector, is accommodated in the second connector.

12. The optical connector according to claim 2, wherein a flange housing portion that houses the flange of the second ferrule is formed in the second connector, and a face of the flange housing portion that opposes the flange of the second ferrule is formed so as to correspond to an outer shape of the flange.

13. The optical connector according to claim 3, wherein a flange housing portion that houses the flange of the second ferrule is formed in the second connector, and a face of the flange housing portion that opposes the flange of the second ferrule is formed so as to correspond to an outer shape of the flange.

14. The optical connector according to claim 11, wherein a flange housing portion that houses the flange of the second ferrule is formed in the second connector, and a face of the flange housing portion that opposes the flange of the second ferrule is formed so as to correspond to an outer shape of the flange.

15. The optical connector according to claim 7, wherein a face of the shaft portion housing groove that opposes the shaft portion of the second ferrule is formed so as to correspond to an outer shape of the shaft portion.
